(19) United States
(12) Patent Application Publication
(10) Pub. No.: US 2007/0219474 A1
(43) Pub. Date: Sep. 20, 2007

(54) Messaging device

(76) Inventors: Tsai Yu Wen, Taipei (TW); Yu Li-Chu, Taipei (TW); Chen Yi-Chia, Tainan City (TW)

Correspondence Address: BRUCE H. TROXELL;SUITE 1404, 5205 LEESBURG PIKE, FALLS CHURCH, VA, 22041, US

(21) Appl. No.: 11/374,144

(22) Filed: Mar. 14, 2006

(51) Int. Cl. A61H 1/00

(52) U.S. Cl. 601/49; 601/70; 601/67

(57) ABSTRACT

A massaging device includes a housing including a recessed top and a channel in the recessed top; a motor having an eccentric shaft securely mounted in the channel; a vibration member mounted on the motor; a massaging pad mounted on the vibration member; and a plurality of rubber cylinders mounted around an edge of the recessed top and secured to a bottom of the vibration member. The housing further includes means for absorbing the force of shocks and jarring generated by the activating motor. A peripheral gap is formed between the motor and an inner surface of the channel. The motor further includes a bottom fan adapted to introduce cool air from an underside of the housing into the housing for dissipating heat generated by the activating motor through the gap.

### BACKGROUND OF THE INVENTION

1. Field of Invention

The present invention relates to massaging devices and more particularly to a vibration-type massaging device with improved characteristics including increased stability during operation.

2. Related Art

Many beneficial effects upon the human body of various forces and motions (e.g., vibration and massage) have long been recognized. Thus, a variety of massaging devices and machines for applying physical forces to the body are commercially available.

A conventional massaging device is shown in FIG. 1 and comprises a base A, a bracket B mounted on the base A, a motor C having an eccentric shaft mounted in the bracket B, a plurality of rubber cylinders D formed around a top edge of the bracket B, a rectangular-shaped cover E put on the base A to seal the above components, a rectangular vibration member F mounted on both the motor C and a top of the cover E, and a rectangular massaging pad G formed on the vibration member F.

However, the prior art suffered from a disadvantage. For example, the bracket B may loosen after a period time of use because the motor C always transmits a strong vibration to the vibration member F during operation. This may compromise the desired vibrating contact between the motor C and the vibration member F. Such condition is worse when the base A is inclined. As an end, great noise is generated and the vibration becomes irregular. An analysis of the cause finds that the bracket B is secured to the motor C by soldering. Such soldering may not precisely mount both the bracket B on the base A and the motor C in the bracket B. As a result, the eccentric shaft of the motor C may shift undesirably. Typically, the cover E is formed by molding and is adapted to provide a protection to the components received therein only. Thus, the need for improvement still exists.

### SUMMARY OF THE INVENTION

It is therefore an object of the present invention to provide a massaging device comprising a housing and a vibration-type motor secured to a channel of the housing wherein the housing comprises means for absorbing the force of shocks and jarring generated by the activating motor, thereby maintaining its stability during operation.

It is another object of the present invention to provide a massaging device comprising a plurality of rubber cylinders mounted between the housing and a top vibration member such that the vibration member is adapted to operate stably.

In one aspect of the present invention the housing can be mass produced easily, the motor is precisely mounted in the channel of the housing, and the housing further comprises a base having a buffer arrangement for further absorbing the force of shocks and jarring generated by the activating motor.

In another aspect of the present invention a peripheral gap is formed between the motor and an inner surface of the channel, and the motor further a bottom fan adapted to introduce cool air from an underside of the housing into the housing for dissipating heat generated by the activating motor through the gap.

In yet another aspect of the present invention the base further comprises a closed groove and a padding member fitted in the groove, and the channel is extended downward to securely receive in the closed groove and engage with the padding member such that the force of shocks and jarring generated by the activating motor can be further absorbed by the padding member.

In a further aspect of the present invention the housing can be shaped as a flat member, a massaging bed, or the like.

The above and other objects, features and advantages of the present invention will become apparent from the following detailed description taken with the accompanying drawings.

### BRIEF DESCRIPTION OF THE DRAWINGS

FIG. 1 is an exploded perspective view of a conventional massaging device;

FIG. 2 is an exploded view of a preferred embodiment of massaging device according to the invention;

FIG. 3 is a sectional view of the assembled massaging device of FIG. 2; and

FIG. 4 is a perspective view of a bed having a plurality of vibration members and massaging pads formed thereon according to another preferred embodiment of massaging device of the invention.

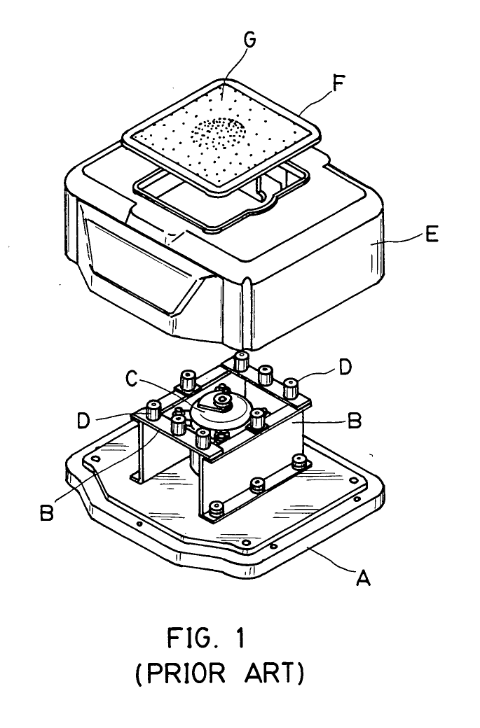

### DETAILED DESCRIPTION OF THE INVENTION

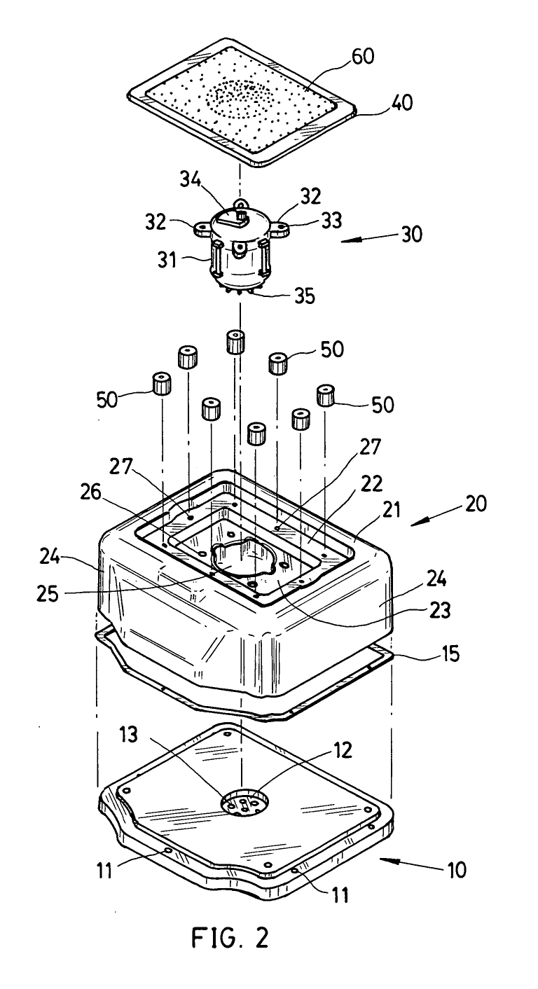

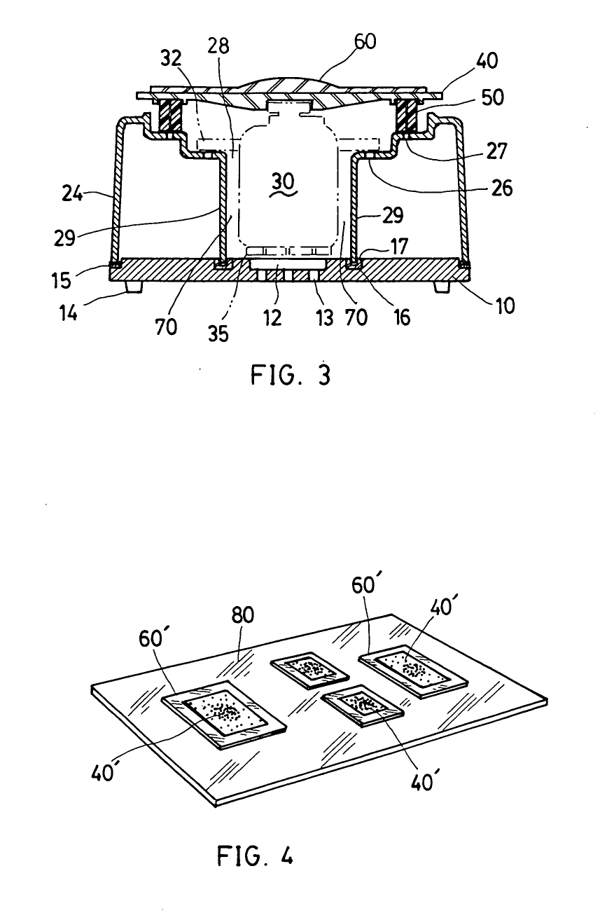

Referring to FIGS. 2 and 3, a massaging device in accordance with a preferred embodiment of the invention comprises a rectangular base 10, a rectangular-shaped cover 20, a motor 30, a rectangular vibration member 40, a plurality of rubber cylinders 50, and a rectangular massaging pad 60. Each component is discussed in detailed below.

The base 10 comprises a plurality of threaded holes 11 around its edge such that the base 10 and the cover 20 may be threadedly secured together. This is well known in the art and a detailed description thereof is therefore deemed unnecessary. Further, the base and the cover 20 may be secured together by means of a different technique. The base 10 further comprises a center recess 12, a plurality of apertures 13 in communication with the recess 12 and its bottom, a plurality of (e.g., four) legs 14 for supporting the base 10 above a supporting ground by a predetermined distance, a peripheral skirt pad 15 or the like mounted between the base 10 and the cover 20 for providing a buffering effect thereto as well known to those skilled in the art, a closed groove 16 formed around the recess 12, and a padding member 17 fitted in the groove 16.

The cover 20 comprises a staged, recessed top 21 having an upper cavity 22 and a lower cavity 23 smaller than the upper cavity 22, a peripheral sidewall 24, a channel 25 through the lower cavity 23, a peripheral inner surface 29 around the channel 25, the inner surface 29 having its lower edge fitted on the padding member 17, a plurality of threaded holes 26 formed on the lower cavity 23, and a plurality of holes 27 formed on the upper cavity 22.

The motor 30 is mounted in the channel 25 such that a peripheral gap 70 is formed between the motor 30 and the inner surface 29. The motor 30 comprises a plurality of (e.g., four) upper projections 32 having a hole 33 such that aligning the holes 33 with the holes 26 and then driving fasteners (e.g., screws) through the holes 33 into the holes 26 will fasten the motor 30 and the cover 20 together. The motor 30 further comprises an eccentric shaft 34 and a bottom fan 35 adapted to introduce cool air from the underside of the base 10 through the apertures 13 into the cover 20 for dissipating heat generated by the activating motor 30 through the gap 70.

The rubber cylinders 50 are aligned with the holes 27 and mounted thereon by threading. The massaging pad 60 is formed on the vibration member 40. The vibration member 40 is mounted on the rubber cylinders 50.

Note that the motor 30 may be mounted in the channel 25 in a manner (e.g., by soldering) other than the above.

The assembled massaging device is advantageous as compared with the prior art since the cover 20 and the base 10 are secured together and the motor 30 is fastened in the channel 25. As a result, the massaging device has an increased stability during operation. Further, vibration transmitted to the inner surface 29 by the activating motor 30 may be absorbed by the padding member 17.

Referring to FIG. 4, in another embodiment of the invention a rectangular bed 80 has a plurality of vibration members 40′, a plurality of massaging pads 60′ both formed thereon, and a plurality of rubber cylinders (not shown) formed thereunder. This embodiment provides another configuration of the massaging device for user choice.

While the invention herein disclosed has been described by means of specific embodiments, numerous modifications and variations could be made thereto by those skilled in the art without departing from the scope and spirit of the invention set forth in the claims.

What is claimed is:

1. A massaging device comprising:
a housing including a recessed top and a channel in the recessed top;
a vibration-type motor having an eccentric shaft mounted in the channel;
a vibration member mounted on the motor;
a massaging pad mounted on the vibration member; and
a plurality of rubber cylinders mounted around an edge of the recessed top and secured to a bottom of the vibration member;
wherein the motor is secured to the housing, and the housing further comprises means for absorbing the force of shocks and jarring generated by the activating motor.

2. The massaging device of claim 1, wherein the housing further comprises a peripheral sidewall and a base secured to the sidewall.

3. The massaging device of claim 2, wherein the base comprises a plurality of apertures for ventilation.

4. The massaging device of claim 1, further comprising a peripheral gap formed between the motor and an inner surface of the channel.

5. The massaging device of claim 2, wherein the channel is extended downward to secure to the base for surrounding the motor.

6. The massaging device of claim 5, wherein the base further comprises a closed groove for securely receiving a bottom edge of the channel.
